(19) United States
(12) Patent Application Publication
(10) Pub. No.: US 2010/0292868 A1
(43) Pub. Date: Nov. 18, 2010

(54) SYSTEM AND METHOD FOR NAVIGATING A REMOTE CONTROL VEHICLE PAST OBSTACLES

(75) Inventors: Efrat Rotem, Haifa (IL); Yaacov Levi, Moza (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL ADVANCED DEFENSE SYSTEMS LTD., Haifa (IL)

(21) Appl. No.: 12/812,036

(22) PCT Filed: Dec. 31, 2008
(86) PCT No.: PCT/IB08/55598

§ 371 Date: Aug. 9, 2010

(30) Foreign Application Priority Data
Jan. 8, 2008 (IL) 188655

(51) Int. Cl. G06F 19/00; H04N 7/18

(52) U.S. Cl. 701/2; 348/114; 348/E07.085

(57) ABSTRACT

A method for navigating a remote control vehicle carrying a video camera which produces a sequence of images, the method comprising tracking a current position of the vehicle as the vehicle moves along a path of motion, determining a location of the current position within a prior image, the prior image having been acquired by the video camera at a previously visited point along the path of motion, and displaying to the operator a graphic display including a representation of the vehicle shown at the location within the prior image.

### FIELD AND BACKGROUND OF THE INVENTION

The present invention relates to manual navigation of remote control vehicles and, in particular, it concerns a system and method for navigating a remote control vehicle carrying a video camera.

Remote control vehicles are useful for a wide range of applications, particularly where it is necessary to collect information or perform a task in a location which is either inaccessible or hazardous for a person to reach. Examples include, but are not limited to, bomb disposal, inspection of burning buildings, urban warfare and navigating through underwater caves.

Navigation of a remote control vehicle is typically straightforward while the vehicle is in direct sight of the operator, but becomes much more problematic when the vehicle is not visible. An onboard video camera with a wireless communications link typically provides the operator with video images of the region ahead of the vehicle. However, these images, typically taken in a forward direction away from the vehicle, are of limited value, particularly when trying to negotiate narrow spaces and other nearby obstacles. By way of example, if a small helicopter-type UAV being navigated through a building carries a forward-directed video camera with a horizontal field of view of about 30 degrees, the video camera will loose sight of the doorposts more than a meter before reaching the doorway and will show only the view into the room. The video image is then useless for gauging the fine clearance between the helicopter rotor and the doorposts, leaving the operator to work by guess or intuition to steer the vehicle through the doorway without collision.

There is therefore a need for a system and method which would provide an operator with additional information and an intuitive interface to facilitate navigation of a remote control vehicle carrying a video camera.

### SUMMARY OF THE INVENTION

The present invention is a system and method for navigating a remote control vehicle carrying a video camera.

According to the teachings of the present invention there is provided, a method for navigating a remote control vehicle carrying a video camera which produces a sequence of images, the method comprising: (a) tracking a current position of the vehicle as the vehicle moves along a path of motion; (b) determining a location of the current position within a prior image, the prior image having been acquired by the video camera at a previously visited point along the path of motion; and (c) displaying to the operator a graphic display including a representation of the vehicle shown at the location within the prior image.

There is also provided according to the teachings of the present invention a remote control vehicle system comprising: (a) a remote control vehicle comprising: (i) a video camera producing a sequence of images, (ii) vehicle controls for controlling motion of the vehicle, and (iii) a communications link for receiving inputs to the vehicle controls and transmitting the sequence of images; and (b) a control interface including: (1) user controls for generating inputs for controlling the vehicle controls, (ii) a display device, and (iii) a communications link for transmitting the inputs and receiving the sequence of images, wherein at least one of the vehicle and the control interface includes at least part of a tracking system for tracking a current position of the vehicle as the vehicle moves along a path of motion, and wherein at least one of the vehicle and the control interface includes a processing system configured to: (A) determine a location of the current position within a prior image, the prior image having been acquired by the video camera at a previously visited point along the path of motion; and (B) generate a graphic display for display on the display device, the graphic display including a representation of the vehicle shown at the location within the prior image.

According to a further feature of the present invention, the tracking is performed at least in part by inertial sensors carried by the vehicle.

According to a further feature of the present invention, the tracking is performed at least in part by processing of the sequence of images.

According to a further feature of the present invention, the tracking includes tracking a current attitude of the vehicle, and wherein the displaying displays a representation of the vehicle indicative of the current attitude.

According to a further feature of the present invention, the displaying displays a representation of the vehicle having dimensions determined as a function of a distance from the previously visited point to the current position.

According to a further feature of the present invention, the prior image is selected as the image taken at a given time prior to reaching the current position.

According to a further feature of the present invention, the prior image is selected as the image taken at a given distance along the path of motion prior to reaching the current position.

According to a further feature of the present invention, the prior image is maintained constant during part of the motion of the vehicle along the path of motion.

According to a further feature of the present invention, an input is received from a user and, responsively to the input, a distance along the path of motion prior to reaching the current position at which the prior image is selected is varied.

According to a further feature of the present invention, an input is received from a user and, responsive to the input, a location on the path of motion at which the prior image is selected is frozen.

According to a further feature of the present invention, a current video image acquired by the video camera at the current position is displayed concurrently with the graphic display.

According to a further feature of the present invention, the graphic display is presented as an inset graphic display within the current video image.

According to a further feature of the present invention, a current video image acquired by the video camera at the current position is displayed, and the graphic display is displayed as an on-demand temporary replacement for display of the current video image.

According to a further feature of the present invention, a subregion corresponding to at least part of a field of view of the current image is identified within the prior image, and an image tile derived from the current image is displayed within the graphic display at a location within the prior image corresponding to the subregion.

According to a further feature of the present invention, the vehicle is an airborne vehicle.

### BRIEF DESCRIPTION OF THE DRAWINGS

The invention is herein described, by way of example only, with reference to the accompanying drawings, wherein:

FIG. 1 is a schematic representation of a system, constructed and operative according to the teachings of the present invention, for navigating a remote control vehicle carrying a video camera;

FIGS. 2A-2C are selected views of a preferred implementation of a display generated by the system of FIG. 1;

FIG. 3 is a sequence of 15 views of a preferred implementation of a display generated by the system of FIG. 1 illustrating the use of the present invention to navigate through a building;

FIGS. 4A and 4B are two selected frames of a sampled video between which a person within the field of view has moved;

FIG. 4C shows a combined image incorporating content from both views of FIGS. 4A and 4B according to a further aspect of the present invention; and

FIG. 4D is a display including the combined image of FIG. 4C as an inset to the current sampled image.

### DESCRIPTION OF THE PREFERRED EMBODIMENTS

The present invention is a system and method for navigating a remote control vehicle carrying a video camera.

The principles and operation of systems and methods according to the present invention may be better understood with reference to the drawings and the accompanying description.

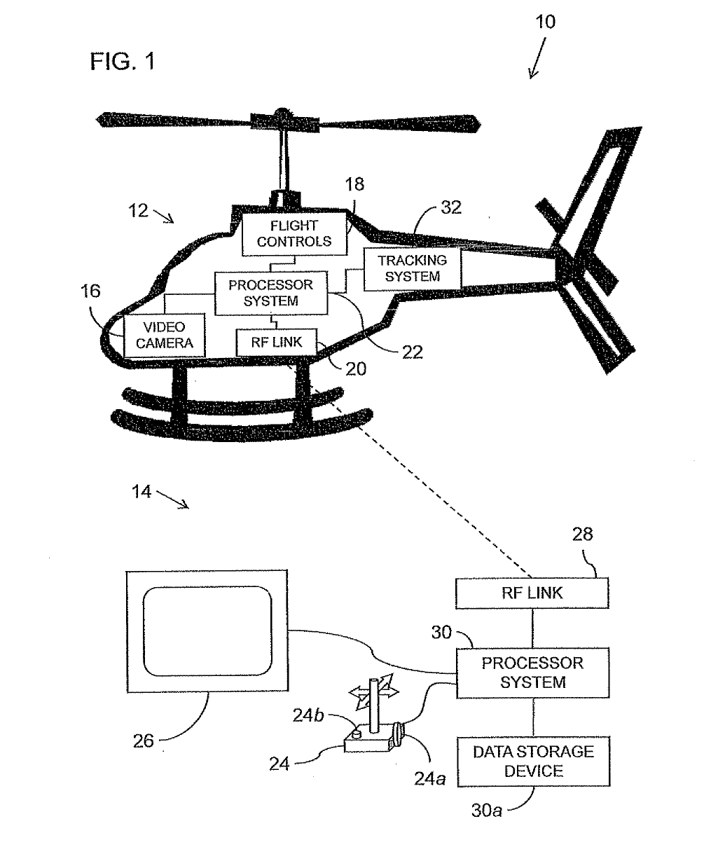

Referring now to the drawings, FIG. 1 illustrates schematically a remote control vehicle system, generally designated 10, constructed and operative according to the teachings of the present invention. In general terms, system 10 includes a remote control vehicle 12 and a control interface 14. Remote control vehicle 12 includes a video camera 16 producing a sequence of images, vehicle controls 18 for controlling motion of the vehicle, and a communications link 20 for receiving inputs to the vehicle controls and transmitting the sequence of images. Video camera 16, vehicle controls 18 and communications link 20 are typically controlled and coordinated by, or integrated with, a processor system 22.

Control interface 14 includes user controls 24 for generating inputs for controlling the vehicle controls, a display device 26, and a communications link 28 for transmitting the inputs and receiving the sequence of images. Here too, user controls 24, display device 26 and communication link 28 are typically controlled and coordinated by, or integrated with, a processor system 30 which is, in turn, associated with a data storage device 30a. Additionally, either vehicle 12 or control interface 14 includes at least part of a tracking system 32 for tracking a current position of vehicle 12 as it moves along a path of motion.

It is a particular feature of the present invention that one of processor systems 22 and 30, or both processor systems working together, are configured to determine a location of the current position of vehicle 12 within a prior image that was acquired by video camera 16 at a previously visited point along the path of motion, and to generate a graphic display for display on display device 26 including a representation of vehicle 12 shown at the location of the current position within the prior image.

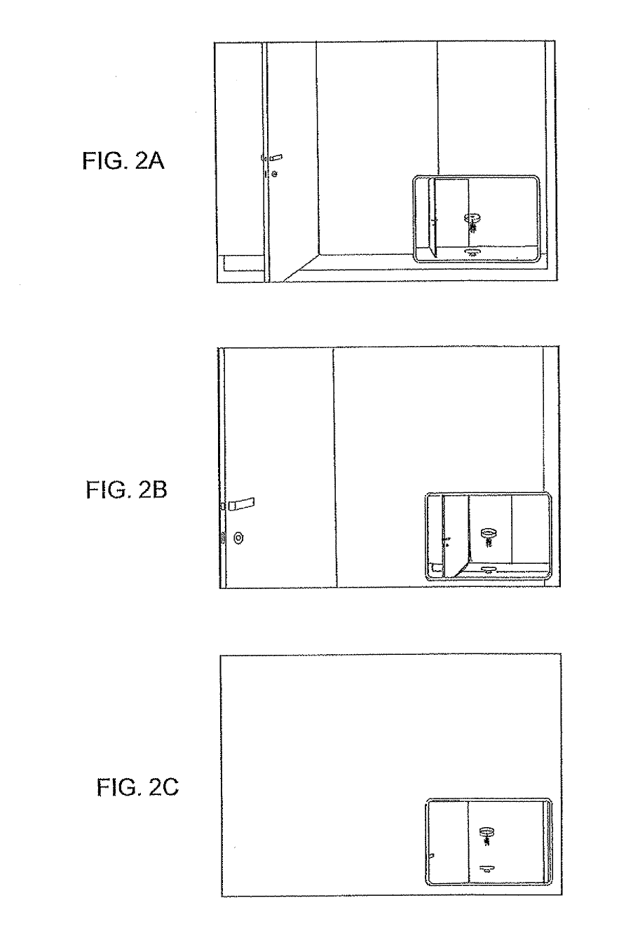

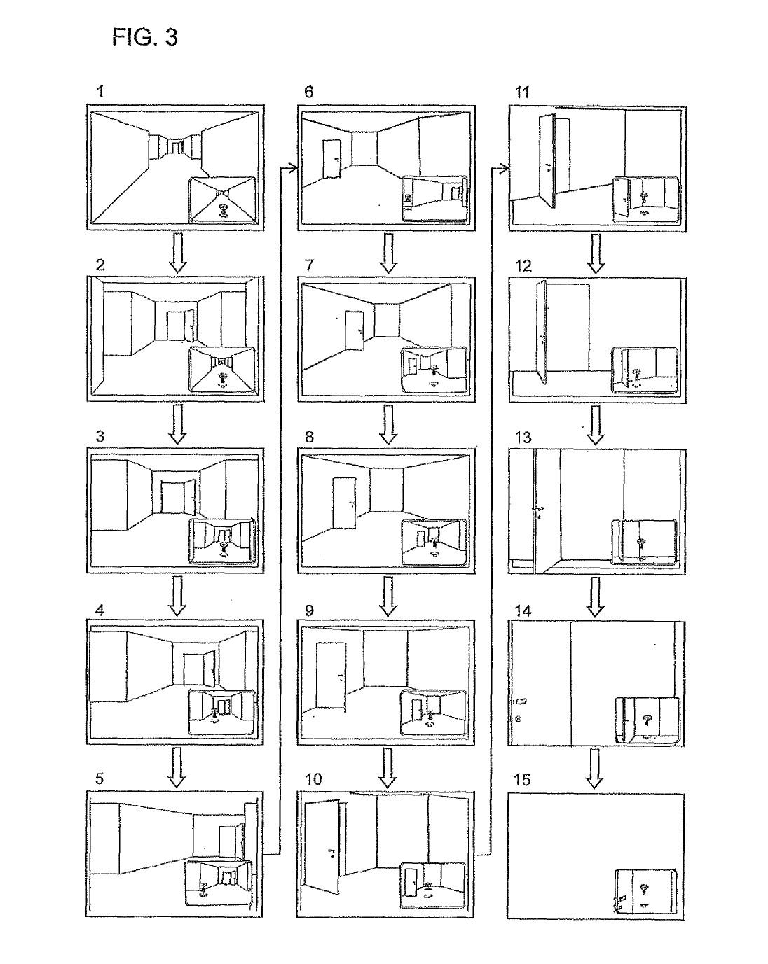

The significant of these features will be better appreciated with reference to FIGS. 2A-2C. Here are shown three views displayed at different times on display device 26 as the vehicle, in this case a miniature helicopter, approaches a doorway. In each case, the main portion of the display shows the currently viewed image seen by the video camera of the vehicle. It can be seen that, as the vehicle approaches the doorway, the opening of the doorway takes over the field of view until, in FIG. 2C, still prior to passing through the doorway, the doorposts are no longer visible. This situation would give rise to the aforementioned problems of reliable navigation through the narrow opening of the doorway. These problems are addressed according to the teachings of the present invention by the inset images in the lower right corner of the display, which show the graphic display generated by the present invention in which a previous frame is used, and a representation of the vehicle is shown at the location within that frame corresponding to the current position of the vehicle. In this manner, the operator of the vehicle is shown a view as if he or she were actually following behind the vehicle as it advances along its path of motion. In this example, the inset of FIG. 2B uses the frame corresponding to the view which was sampled in FIG. 2A, while the inset of FIG. 2C employs the view sampled in FIG. 2B. The operator thus sees the vehicle in the context of a view which still contains the outline of the doorframe, thereby rendering navigation of the vehicle through the doorway straightforward and intuitive.

FIG. 3 shows a more extensive sequence of display screens as the vehicle is navigated along a corridor, around a left turn and then through a doorway on the left hand side. At each stage, the inset image, preferably updating at a video frame rate similar to the sampled video, provides a valuable intuitive representation of the current position of the vehicle in the context of a previously captured image, thereby facilitating proper orientation and judgment of steering by the remote operator. At the same time, according to this preferred implementation, the simultaneously displayed real-time video image provides feedback on any upcoming or moving obstacles which may not have been visible from the previous viewpoint.

At this stage, it will be helpful to define certain terminology as used herein in the description and claims. The term “vehicle” is used herein to refer to any and all vehicles which can be remotely controlled by an operator. Examples of vehicles with which the present invention may be implemented to advantage include, but are not limited to, unmanned aerial vehicles (UAV) of all types and sizes, unmanned surface vehicles (USV) of all types and sizes, unmanned water craft, unmanned underwater vehicles and vehicles for navigating through tunnels. The invention is believed to be of particular significance in the context of highly maneuverable vehicles such as hovering vehicles (e.g., rotary wing or “helicopter type” vehicles) which have the capability of negotiating past obstacles with small margins of clearance.

The term “navigate” is used generically to refer to the act of flying, driving, sailing, steering or otherwise directing the course of the vehicle, all as appropriate to the type of vehicle in question.

The term “video camera” is used to refer to any imaging system which provides a sequence of optical images sampled within any part or parts of the visible or invisible light spectrum in substantially real time. Examples include, but are not limited to, video cameras operating in the visible or near infrared ranges based on CCD or CMOS focal plane array sensors, and various types of deep infrared heat-sensing cameras such as FLIR sensors. The term “video” is used loosely to refer to generation of an ongoing sequence of images without necessarily requiring a frame rate which would normally be considered continuous video quality. In most cases, however, video frame rates of 30 frames per second or higher are employed.

Turning now to the remaining features of the invention in more detail, the communication system between vehicle 12 and control interface 14 may be implemented using any type of communication link suited to the intended application. In most preferred implementations, an untethered communication link, such as a wireless RF link 20, is used. However, other communication systems, including but not limited to: microwave, infrared and sound-wave transmitted communication, and trailing fiber-optic communication links, may also be used.

Navigation controls 18 are the normal navigation controls appropriate to the type of vehicle with which the invention is implemented. In the preferred case of a helicopter-type vehicle as illustrated, navigation controls 18 are implemented as the standard flight controls of the vehicle.

Although illustrated here with a processing system 22 in the vehicle 12, the subdivision of functions between vehicle processing system 22 and control interface processing system 30 may be varied, and processing system 22 may in certain cases be omitted entirely. In such cases, minimal interfacing circuitry (hardware or firmware) is provided to deliver images from video camera 16 via RF link 20 to control interface 14 and to deliver received control signals to actuators of the navigation controls 18, as well as any interfacing required with components of tracking system 32.

Tracking system 32 may be implemented in a wide range of ways. Although illustrated in FIG. 1 as a sub-element carried by vehicle 12, it will be appreciated from the following description that various implementations of tracking system 32 may not actually require any additional structural components carried by vehicle 12, the tracking system instead being implemented as a module of processing system 30 based upon images from video camera 16 and/or other vehicle-mounted sensors.

In the case of a vehicle with an inertial navigation system (INS) including a plurality of inertial sensors, the INS itself typically functions as the tracking system. When no INS is present, a full or reduced set of inertial sensors may be provided as a dedicated tracking system 32. Alternatively, or additionally, one or more rangefinder sensor may be used to monitor variations in distance from surfaces such as the ground and walls. For surface vehicles, tracking in two dimensions linear dimensions parallel to the surface may be sufficient, preferably together with the angular bearing (azimuth). For airborne vehicles, tracking in at least three dimensions is typically required, and most preferably, tracking in six degrees of freedom, specifying both position and attitude of the vehicle. It should be noted in this context that the tracking of the present invention typically need only be tracking of relative position over a relatively short period in order to provide sufficient information about the spatial relation of the video frames used. In many cases, sensor drift of a few percent per second may be acceptable. As a result, relatively low cost and low precision sensors may be sufficient.

Alternatively, or additionally, tracking system 32 is configured to process the sequence of images to derive information relating to a current position of the vehicle. This approach is typically based on techniques for deriving ego-motion of a camera, which is often performed as part of “structure from motion” (“SFM”) techniques where a series of images taken from a moving camera are correlated and processed to simultaneously derive both a three dimensional model of the viewed scene and the “ego-motion” of the camera. Examples of algorithms suitable for deriving real-time ego-motion of a camera are known in the art, and include those described in U.S. patent application Ser. No. 11/747,924 and the references mentioned therein. Real-time SFM techniques are typically computationally intensive. However, since only the ego-motion of the camera is required for implementation of the present invention, considerable simplification of the computation is possible. For example, the ego-motion can typically be derived using sparsely distributed tracking points which would be insufficient for derivation of a full structural model of the scene. Furthermore, since only relatively short term tracking is required, it is typically not necessary to maintain consistent registration between widely spaced frames in the video sequence. These facts typically greatly reduce the computational burden of implementing the method. In cases where information about the three-dimensional environment within which the vehicle is moving is available from a pre-existing database or from any other source, the calculations of ego-motion of the camera may be further simplified. Image processing-based tracking implementations typically employ tracking system 32 based at the control interface 14 or at some other remote location to which the image frames are transferred.

In certain cases, a hybrid approach employing both image processing and inertial sensor measurements may be used, either providing drift cancellation to the inertial sensors based on the image processing or providing estimated motion parameters to the image processing system to simplify calculations.

A further option for providing information relating to a current position of the vehicle is the use of a three-dimensional camera, i.e., a camera which provides depth information. An example of such a camera is commercially available from 3DV Systems Ltd. of Yokneam, Israel. The camera may be the primary video camera 16 of the invention, or may be a supplementary sensor dedicated to the tracking function. By use of known algorithms to detect (and in this case reject) moving objects, the ego-motion of the camera can readily be derived from variations in range to the various static objects in the camera field of view of through direct correlation of the three-dimensional images, as will be clear to one ordinarily skilled in the art.

It should be noted that tracking system 32 is not limited to the above examples, and may be implemented using a range of other tracking systems, or a hybrid of different systems. The choice of system may depend also on the expected environmental conditions and accessibility of the locale, and on the degree of accuracy required in the measurements, all according to the intended application. Other technologies which may be used include, but are not limited to, systems employing GPS technology, and systems employing triangulation, time-of-flight or other techniques relative to dedicated beacons emitting RF or other wireless signals.

In most preferred implementations, tracking system 32 tracks not only the position of the vehicle but also the attitude (e.g., pitch, yaw and roll). Most preferably, the attitude is also depicted in the visual representation of the vehicle displayed to the operator, thereby allowing the operator to see whether the vehicle is proceeding appropriately in the intended direction. Similarly, the representation of the vehicle is preferably scaled as a function of the distance of the current position from the effective viewpoint of the selected prior frame (and taking into account any zoom factor used in the display), thereby giving the user an intuitive perception of the position of the vehicle.

The choice of which prior frame to use for generating the display of the present invention may be made according to various criteria and/or operator inputs. According to one approach, the processing system selects the prior image as the image taken at a given time prior to reaching the current position. The time period is selected according to the normal speed of motion of the vehicle. For a range of applications, a time period in the range of about 1 second to about 5 seconds is believed to be suitable.

In other cases, particularly where the vehicle can travel at very low speeds of even stop, it may be preferable to choose the image taken at a given distance along the path of motion prior to reaching the current position.

In particularly preferred implementations, the operator is provided with user controls which allow him or her to control the choice of prior image, and hence adjust the effective viewpoint from which the vehicle position is viewed. In one example, a viewpoint adjustment control such as thumbwheel 24a allows the user to vary a distance along the path of motion prior to reaching the current position at which the prior image is selected. Thus, for example, if the operator wants to see the position of the vehicle in a broader context, he can roll back the prior image to an image taken at a greater distance prior to the current position whereas, for fine maneuvers, the user can roll forward the prior image to a viewpoint from which the synthesized image of the vehicle fills most of the field of view. Parenthetically, depending upon the resolution of the sampled images, an additional or alternative user control could be implemented as a zoom-in/zoom-out control in which the choice of background frame is not changed but the magnification and cropping are varied to provide different levels of context or detail around the representation of the vehicle.

Another user control which may advantageously be provided is a viewpoint freeze control, such as button 24b, wherein activates the processing system to freeze a location on the path of motion at which the prior image is selected. The user may thus select a good viewpoint from which to view a series of maneuvers to be performed. In some cases, the operator may specifically choose a route of travel in order to provide the desired viewpoint from which to display the subsequent maneuvers. Although the background frame is frozen, the representation of the vehicle is continuously updated in real time. The operator then presses button 24b again to return to the normal “follow-me” style of display where the display appears to follow at a time interval or spacing behind the vehicle. In certain cases, the system may be configured to provide simultaneous graphic displays based on two or more different prior images with different viewpoints, for example, a more distant frozen overview display and a follow-me display, or two angularly spaced viewpoints to give enhanced depth perception.

A further specific example of the simultaneous use of two viewpoints is the use of two similar but spatially separated prior images supplied independently to two eyes of the operator to provide stereoscopic depth perception. This option is feasible even where no three-dimensional information has been obtained about the surroundings.

As an alternative, or addition, to the aforementioned user controlled selection of the prior image used, the system may implement various algorithms for automated selection of an appropriate prior image. By way of one non-limiting example, the prior image may be set to default as an image sampled at given distance along the path of motion prior to the current position, and may be varied as necessary in order to keep the vehicle within the field of view of the prior image. Thus, for example, the prior image will typically be adjusted to be taken from a viewpoint further back along the track during sharp cornering. Where an adjustment to the viewpoint is required, the adjustment is preferably performed gradually so as to avoid confusing the user by sudden jumps of viewpoint.

As mentioned above, the navigation-aiding graphic display of the present invention is most preferably displayed as a supplement rather than a replacement for the current video image display. In the preferred implementation illustrated in FIGS. 2A-2C and 3, the graphic display is shown as an inset within the larger current video image. Clearly, this layout may be varied, or the images may be displayed on separate display devices. In certain implementations, the operator preferably has control over the display layout between a number of different options including one or more of the following: large navigation-aiding graphic display only; large navigation-aiding graphic display with inset current video image; even size split screen; large current video image with inset large navigation-aiding graphic display (as shown); and large current video image only.

By way of example, certain implementations of the system and method of the present invention provide the navigation-aiding graphic display only on demand. In this case, normal use of the remote controlled vehicle proceeds in a conventional manner with the operator typically viewing real-time sensor input (current video image) only. When the operator encounters an obstacle, he or she actuates the navigation-aiding mode in which the display is provided with the graphic display of the invention as described above, as either a supplement or replacement for the current video image. In an “on-demand” implementation, the navigation-aiding display may optionally always be a “frozen” frame, with the frame being selected either by the operator or automatically according to one of the options described above. The display may revert to the normal current-video-only display when the obstacle has been passed, either in response to a further input from the operator, or automatically according to some criterion, for example, the vehicle exiting from the field of view of the frozen image.

Where three dimensional information about the environment is available, either through SFM processing, by use of a three-dimensional camera or from any another source, additional optional functionality may be provided. For example, the system may derive an estimated distance from the vehicle to an obstacle (e.g., from the helicopter rotor to a wall or doorpost), and generate a visible indication and/or warning sound indicative of the clearance or of an impending collision, thereby improving user awareness of the distance from the vehicle to the obstacle. An example of a visible indication is a synthesized shadow cast onto the wall or floor so that the shadow becomes closer to the vehicle as the clearance reduces. Where this shadow function is desired without full information about the environment, a similar effect may be achieved on the basis of measurements by a downward-looking rangefinder deployed to measure the distance from the vehicle to the ground. A similar function may be provided in the form of an an audio indication, such as a tone which goes up in pitch and/or volume, or audio pulses which become more frequent, as the clearance decreases.

As a more sophisticated alternative, or supplement, to the use of shadow, user perception of the vehicle position relative to its environment may be enhanced by providing the representation of the current vehicle position in the context of a stereo-vision three-dimensional image using a suitable three dimensional display device (e.g., head mounted stereovision goggles or projected polarized or red/green color separations). The stereo-images may be derived by any available techniques, for example, being rendered from a three-dimensional model, such as may have been derived by SFM computation, or being derived directly from the video sequence by techniques such as those described in U.S. Pat. No. 7,180,536 B2. One or both of the images may be a modified version of the “prior image”, as required by the stereo image-pair generating technique and by the type of stereo-vision display technique used.

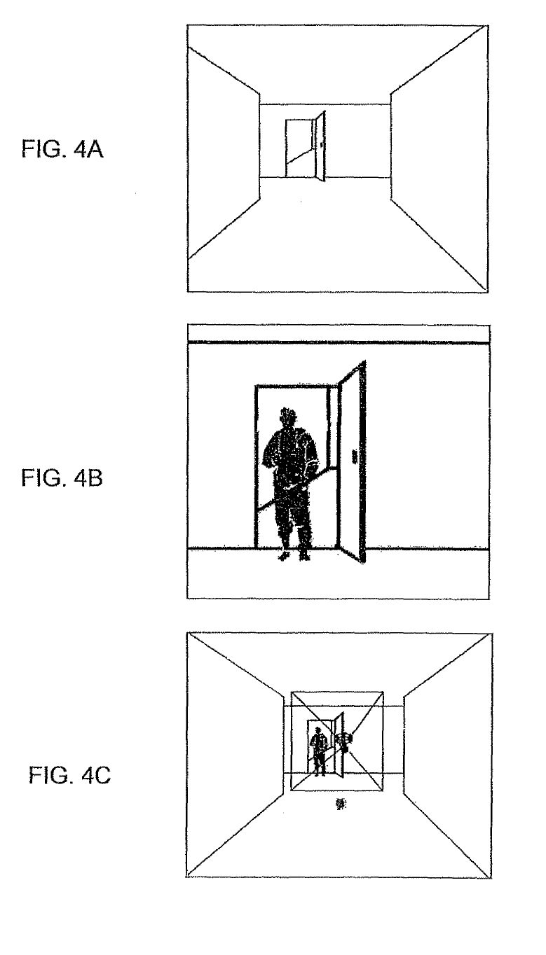

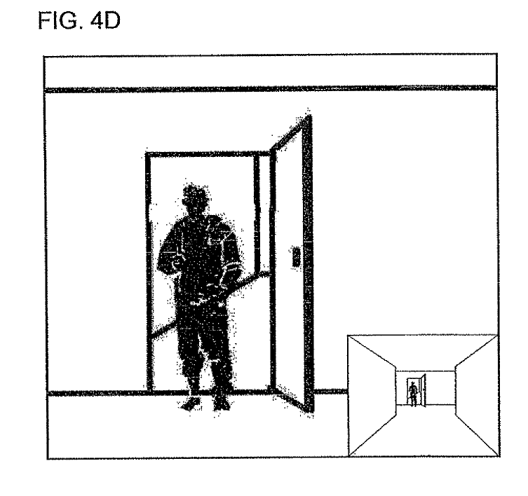

Turning now to FIGS. 4A-4D, there is illustrated a further optional feature of the present invention. One possible shortcoming of using a display based on a prior frame of video, particularly where the view of the present invention is displayed alone, is that the display does not contain up-to-date information regarding fast moving objects. For example, in the case illustrated here, a “prior image” as illustrated in FIG. 4A shows an empty doorway while the “current image” as illustrated in FIG. 4B shows a person who has appeared since the prior frame was captured. A synthesized view according to the teachings of the present invention described thus far would fail to show the rapidly changing details of the scene (in this case, the person), and would therefore risk misleading user.

To address this issue, certain preferred implementations of the present invention are configured to identify within the prior image a region corresponding to the current image, and to substitute into the prior image the suitably scaled and warped tile based on the current image. The resulting combination image is illustrated in FIG. 4C, where the rectangular box adjacent to the representation of the vehicle corresponds to the substituted region. This display advantageously combines a representation of the current position of the vehicle relative to a previous viewpoint while at the same time presenting to the user the most up-to-date information available. The tracking information described above provides the relative geometry between the current position and the prior position of the camera, thereby providing the necessary parameters for warping the current image to appear to be from a similar viewing angle as the prior image. FIG. 4D illustrates the corresponding graphic display if the synthesized image is to be viewed as an inset image alongside the primary current video image.

Finally, it should be noted that the video camera of the present invention is not necessarily fixed to move with the vehicle, but may be gimbaled. The relative attitude of the camera to the vehicle is typically known from the gimbal mechanism. In such a case, it may be advantageous to display a cone or other geometrical representation emanating from the representation of the vehicle so as to illustrate the current viewing direction of the video camera. This may further facilitate interpretation of the relationship between the current image and the displayed prior image, particularly where the fields of view do not overlap.

It will be appreciated that the above descriptions are intended only to serve as examples, and that many other embodiments are possible within the scope of the present invention as defined in the appended claims.

1. A method for navigating a remote control vehicle carrying a video camera which produces a sequence of images, the method comprising:
(a) tracking a current position of the vehicle as the vehicle moves along a path of motion;
(b) determining a location of said current position within a prior image, said prior image having been acquired by the video camera at a previously visited point along the path of motion; and
(c) displaying to the operator a graphic display including a representation of the vehicle shown at said location within the prior image.

2. (canceled)

3. (canceled)

4. The method of claim 1, wherein said tracking includes tracking a current attitude of the vehicle, and wherein said displaying displays a representation of the vehicle indicative of said current attitude.

5. The method of claim 1, wherein said displaying displays a representation of the vehicle having dimensions determined as a function of a distance from said previously visited point to said current position.

6. The method of claim 1, wherein said prior image is selected as the image taken at a given time prior to reaching the current position.

7. The method of claim 1, wherein said prior image is selected as the image taken at a given distance along the path of motion prior to reaching the current position.

8. The method of claim 1, wherein said prior image is maintained constant during part of the motion of the vehicle along said path of motion.

9. The method of claim 1, further comprising receiving an input from a user and varying, responsively to said input, a distance along the path of motion prior to reaching the current position at which said prior image is selected.

10. (canceled)

11. The method of claim 1, further comprising displaying concurrently with said graphic display a current video image acquired by the video camera at said current position.

12. (canceled)

13. The method of claim 1, further comprising displaying a current video image acquired by the video camera at said current position, and wherein said graphic display is displayed as an on-demand temporary replacement for display of said current video image.

14. The method of claim 1, further comprising:
(a) identifying within said prior image a subregion corresponding to at least part of a field of view of said current image; and
(b) displaying within said graphic display an image tile derived from said current image at a location within said prior image corresponding to said subregion.

15. The method of claim 1, wherein the vehicle is an airborne vehicle.

16. A remote control vehicle system comprising:
(a) a remote control vehicle comprising:
(i) a video camera producing a sequence of images,
(ii) vehicle controls for controlling motion of the vehicle, and
(iii) a communications link for receiving inputs to said vehicle controls and transmitting said sequence of images; and
(b) a control interface including:
(i) user controls for generating inputs for controlling said vehicle controls,
(ii) a display device, and
(iii) a communications link for transmitting said inputs and receiving said sequence of images,
wherein at least one of said vehicle and said control interface includes at least part of a tracking system for tracking a current position of the vehicle as the vehicle moves along a path of motion,
and wherein at least one of said vehicle and said control interface includes a processing system configured to:
(A) determine a location of said current position within a prior image, said prior image having been acquired by said video camera at a previously visited point along the path of motion; and
(B) generate a graphic display for display on said display device, said graphic display including a representation of the vehicle shown at said location within the prior image.

17. (canceled)

18. (canceled)

19. The remote control vehicle system of claim 16, wherein said tracking system is operative to track a current attitude of the vehicle, and wherein said processing system generates said representation of the vehicle indicative of said current attitude.

20. The remote control vehicle system of claim 16, wherein said processing system selects said prior image as the image taken at a given time prior to reaching the current position.

21. The remote control vehicle system of claim 16, wherein said processing system selects said prior image as the image taken at a given distance along the path of motion prior to reaching the current position.

22. The remote control vehicle system of claim 16, wherein said processing system employs a single prior image during part of the motion of the vehicle along said path of motion.

23. The remote control vehicle system of claim 16, wherein said user controls include a viewpoint adjustment control, and wherein said processing system is responsive to said viewpoint adjustment control to vary a distance along the path of motion prior to reaching the current position at which said prior image is selected.

24. (canceled)

25. The remote control vehicle system of claim 16, wherein said display device displays a current video image acquired by the video camera at said current position together with said graphic display.

26. (canceled)

27. The remote control vehicle system of claim 16, wherein said graphic display is displayed as an on-demand temporary replacement for a display of said current video image.

28. The remote control vehicle system of claim 16, wherein said vehicle is an airborne vehicle.
